(19) United States
(12) Patent Application Publication
(10) Pub. No.: US 2009/0320668 A1
(43) Pub. Date: Dec. 31, 2009

(54) Pinky Pal

(75) Inventor: Erik Matthew Jacobsen, Mahwah, NJ (US)

Correspondence Address: Erik Jacobsen, 1283 Paddington Road, Mahwah, NJ, 07430, US

(73) Assignee: Erik Matthew Jacobsen, Mahwah, NJ (US)

(21) Appl. No.: 12/217,103

(22) Filed: Jun. 30, 2008

(51) Int. Cl. G09B 15/00

(52) U.S. Cl. 84/470 R

(57) ABSTRACT

The Pinky Pal is a foam manipulative for trumpet players that helps to promote proper right hand position when playing the trumpet. The Pinky Pal retrofits over all manufactures brands of student model trumpets in which the trumpet's existing finger hook is positioned into the Pinky Pal and then slid over the existing trumpet finger hook with the Pinky Pals flaps falling onto both sides of the trumpet's top tubing. The Pinky Pal is then further secured underneath the trumpet's tubing by the Velcro found on the inside of the Pinky Pal flaps. The Pinky Pal is made up of a single piece of rectangular shaped EVA foam with a finger hole on the top, a center cut reaching halfway up the middle from the bottom (creating flaps) and a slit in the middle just below the finger hole for the trumpet's finger hook. The Pinky Pal helps trumpet players train their right hand pinky finger to stay in place atop the trumpets finger hook instead of inside the finger hook. The Pinky Pal also gives a lift to the right hand resulting in pressing down of the valves and not pulling down the valves.

### BACKGROUND OF THE INVENTION

1. The Pinky Pal pertains generally to musicians. More specifically, the Pinky Pal relates to the beginning student trumpet player in association with the trumpets existing finger hook. The Pinky Pal possess a unique design, which includes a finger hole for the right hand pinky to be placed into, which is retrofitted above the trumpets existing finger hook and thus establishing a lift of the right hand for promoting proper playing technique. The Pinky Pal is further provided with a 10 millimeter slit below the finger hole thereby affording flexibility in the retrofitting upon a wide range of older trumpets, professional trumpets and all manufactures of student model trumpets.

A practical example of the flexibility possessed by the Pinky Pal resides in its ability to allow trumpet players of both small and larger pinky finger sizes to place their fingers easily into its spongy and flexible finger hole. Being fabricated from foam enables the Pinky Pal to stretch in various different directions and tolerate harsh pulling, pushing and twisting while still maintaining its integrity and objective.

In addition to the foregoing attributes, the Pinky Pal possesses numerous educational benefits. Educational features of the invention include learning to hold the trumpet correctly, a reduction in off task time, and because of its unique appearance and texture, a renewed student interest in lesson time. Moreover, because of its simplicity in use and ease of installation, proper hand posture translates into more attention applied to other playing details. Furthermore, since proper hand position is a problem common among novice trumpet students the invention assists the teacher in the large classroom setting by eliminating the need for constant checking for understanding as it pertains to correct right hand posture resulting in further focus on additional elements of learning.

It can thus be seen that the present invention provides a novel addition to the music teacher's instructional repertoire of inspirational tools which successfully integrates educational fun and learning while nonetheless adhering to the proper principles of correct right hand trumpet techniques.

### DESCRIPTION OF PRIOR ART

A detailed search has failed to produce a single element regarding the retrofitting of a manipulative to a trumpets existing finger hook in order to correct, instill or promote proper right hand finger technique.

### SUMMARY OF THE INVENTION

The objective of the Pinky Pal is to promote proper right hand posture and finger technique for trumpet players. The Pinky Pal aids in the education of trumpet students by facilitating the right hand pinky finger to stay in place atop the trumpets finger hook instead of inside the finger hook and furthermore assists the teacher in saving valuable instructional time by not having to continuously correct and demonstrate proper hand position. In addition to the foregoing, the invention automatically lifts the right hand of the user into the correct position point to properly press the trumpets valves down and alleviate the pulling of the valves common to most novice and untrained trumpet players.

Additionally, the invention is easy to retrofit by the user onto all student model trumpets and can be left on the instrument even when the instrument is placed back into its carrying case.

### BRIEF DESCRIPTION OF THE DRAWINGS

FIG. 1 is the side view of the present invention;

FIG. 2 is the front view of the present invention;

FIG. 3 is a side plain view of the invention as it appears when retrofitted to the trumpet;

FIG. 4 is a front view of the Velcro flaps of the present invention; and

FIG. 5 is a plain view picture of the invention being utilized with an actual trumpet.

### DESCRIPTION OF THE PREFERRED EMBODIMENT

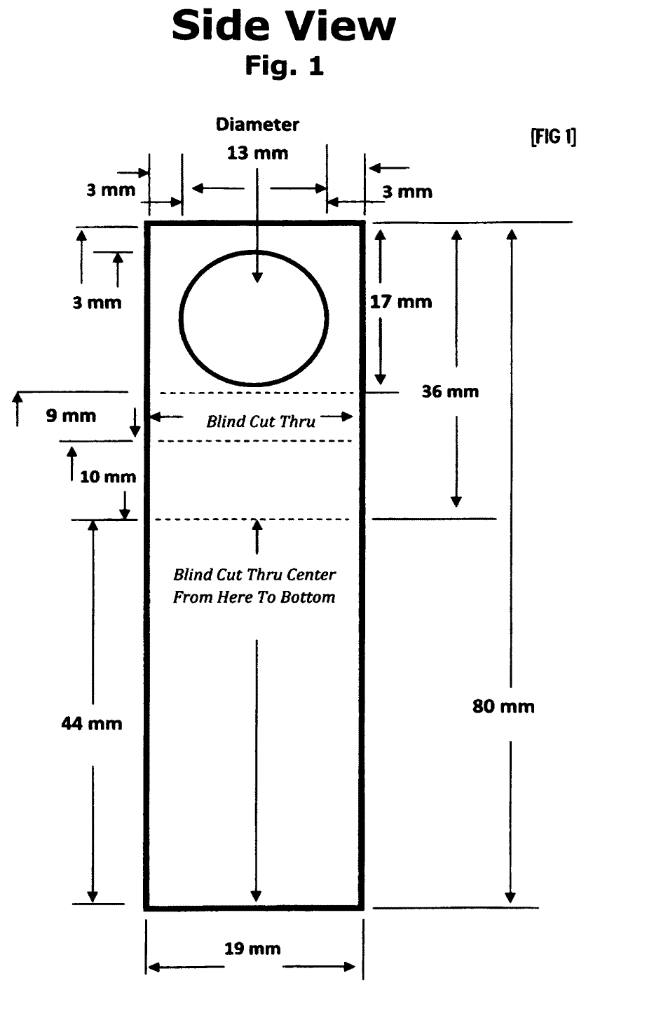

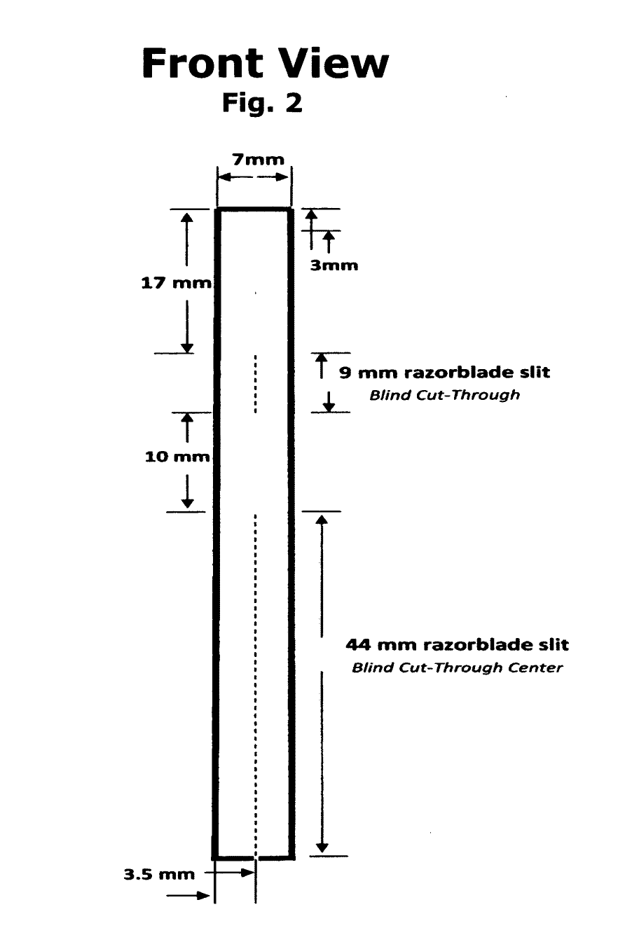

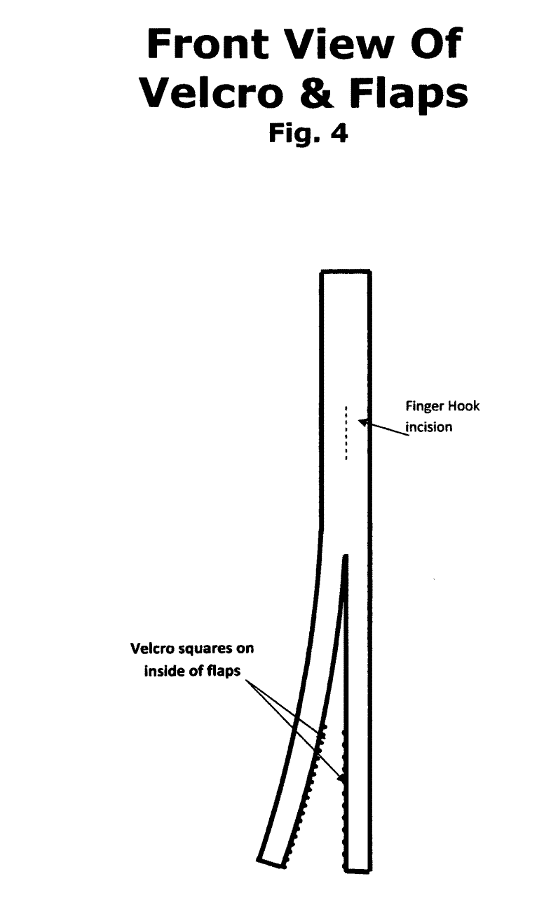

With reference to the drawings and, in particular, with reference to FIGS. 1, 2 & 4, the Pinky Pal comprises a rectangular body, fabricated from a sheet of closed cell EVA memory foam material, preferably at a durometer approximately 55-60 Asker C. The body is defined by a front side, a rear side, a top side, a bottom side, a left side, and a right side. A plurality of flaps or apertures are provided from the center of the body, extending to the bottom side as most clearly shown in FIG. 4. Illustrated in FIGS. 1 & 3, is the pinky hole centered just below the top side.

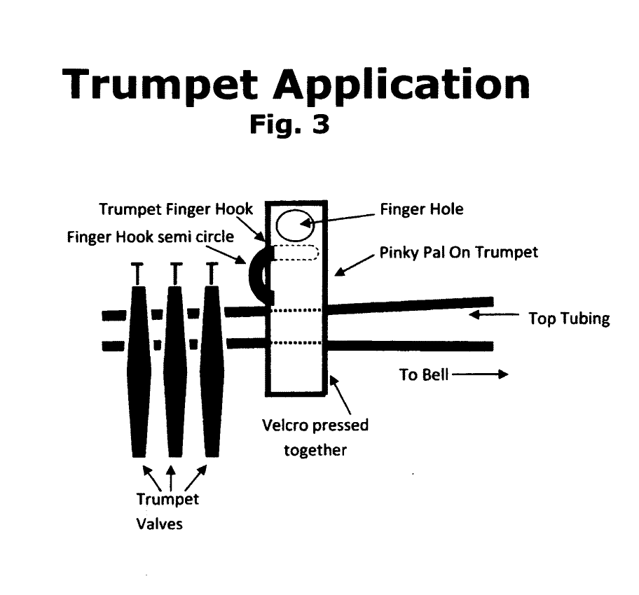

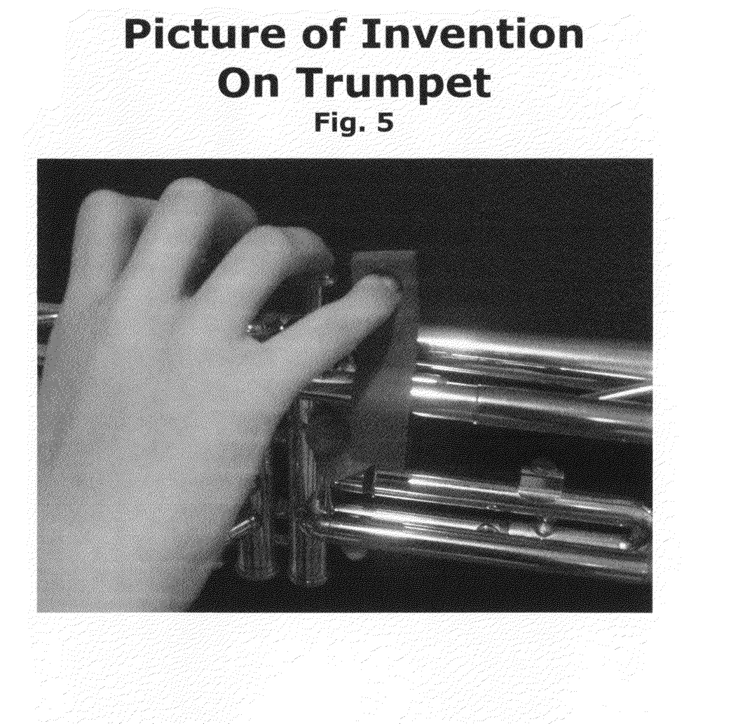

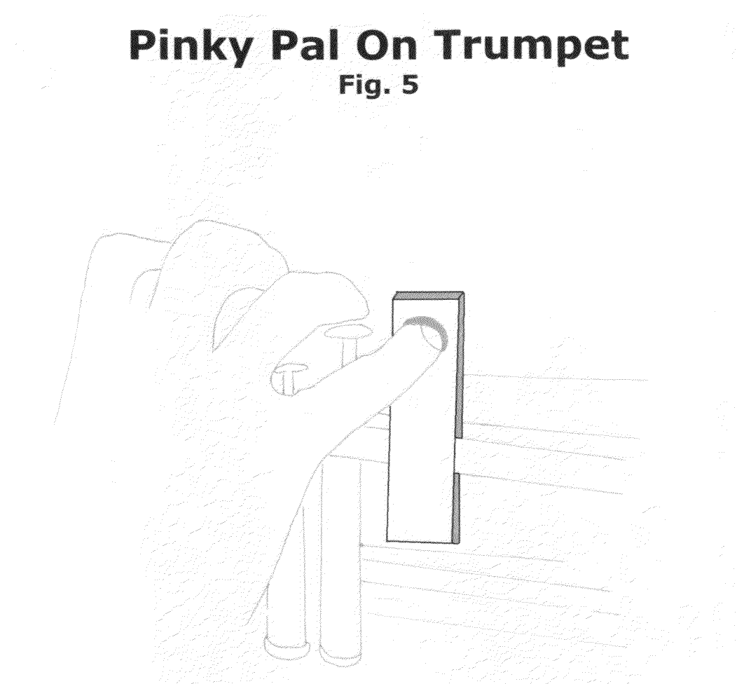

As depicted in FIG. 5, the foam is cut in the body to form two parallel flaps. The flaps, as further shown in FIG. 4, are lined with Velcro material evenly aligned with respect to each other. With further reference to FIGS. 3 & 5, The duel flaps are both pressed together to form a secure non-invasive bond.

As particularly shown in FIG. 1, a blind incision is prepared below the Centered hole in the Pinky Pals body by way of the front side to the back side terminating out of both ends clearly. FIGS. 2 & 4, depict the incision as it appears on the front of the Pinky Pals body. Thus, it can be seen that the incision is surrounded by the foam body on its top side, bottom side, left side, and right side.

The Pinky Pal as so described, is adapted to mate with a trumpets male finger hook as depicted in (FIG. 3) by first making contact with the blind female incision shown clearly in (FIG. 1). The trumpets finger hook is then inserted into the passageway of the invention. Full insertion of the invention is achieved when it firmly abuts the circular end portion of the trumpets finger hook. As illustrated therein, the walls of the blind incision provide first and second contact points for the trumpets finger hook member and thereby prohibiting forward and backward movement of the invention.

Once the Pinky Pal has abutted the circular portion of the trumpets finger hook, as previously discussed, the duel flaps are then pressed together further prohibiting side to side movement of the invention providing redundancy and a firm and secure placement on the trumpet.

After mounting the Pinky Pal to the trumpets finger hook, it is recommended that the Pinky Pal is left in place on the instrument until it is no longer needed at the users discretion. The Pinky Pal can remain on the trumpets finger hook and stored with the trumpet as it is placed in its carring case for future use without any consequence to the invention.

FIG. 3 illustrates the inventions finger hole that is adapted to provide flexibility to accommodate both small and medium sized pinky fingers through an expandable foam pinky hole. The application of the user can be seen in FIG. 5. In order to secure the users pinky, with respect to the finger hole, the Pinky Pals foam fabrication material surrounds the users pinky finger and offers suppleness in compliance with the actions of said pinky finger.

The present invention, therefore provides an manipulative for the trumpets finger hook in the form of a flexible foam rectangle containing a plurality of dual foam flaps which are provided on the interior with Velcro lining for securing directly below the trumpets top tubing and a blind female incision for simultaneously engaging the trumpets male finger hook, and having a hole for insertion of the users pinky finger.

Although the invention has been described in connection with a preferred embodiment, it should be understood that various modifications, additions and alterations may be made to the invention by one skilled in the art without departing from the spirit and scope of the invention as defined in the appended claims.

The embodiments of the invention in which an exclusive property and privilege is claimed are defined as follows:

1. I claim that the Pinky Pal forms a rectangle comprised of the combination of a plurality of flaps affixed on the inside portion comprised of Velcro on the Lower portion a trumpet finger hook slot in the middle above the flaps for accepting the trumpet finger hook and a hole cut out above the trumpet hook slot for the user's right hand pinky finger.

2. I claim that said Pinky Pal in combination defined in claim 1, Wherein said trumpet finger hook slot in the middle above the flaps for accepting the trumpet finger hook allows for expansion in the acceptance of all size, shapes and manufactures models of student model trumpet finger hooks.

3. I claim that the combination defined in claim 1 wherein the flaps are affixed on the inside portion with Velcro are then pressed together around the trumpets top tube whereby said Pinky Pal, in combination with claim 2, form a secure fit on the trumpet.

4. I claim that said Pinky Pal in combination defined in claims 1, 2 & 3 will help to keep the users right hand pinky finger in place, above said trumpets finger hook, while the user plays the trumpet.

5. I claim that said Pinky Pal in combination defined in claim 4, will help to keep the index, middle and ring fingers from pulling down the trumpets' valves

6. I claim that said Pinky Pal in combination defined in claims 4 & 5, will help to promote the index, middle and ring fingers to push down the trumpets' valves.

7. I claim that said Pinky Pal in combination defined in claims 4, 5, & 6 will help to promote good right hand posture when playing the trumpet.

8. I claim that said Pinky Pal in combination defined in claims 4, 5, 6 & 7 will give users a solid foundation and understanding of proper right hand trumpet technique.

9. I claim that said Pinky Pal in combination defined in claims 1 & 2 will close off the existing finger hooks semi-circular portion of said trumpets finger hook.

10. I claim that said Pinky Pal in combination defined in claim 9 will reinforce the proper use of said trumpets finger hook which is to have users place their right hand pinky finger on top of said trumpets finger hook and not inside the trumpets finger hook.

11. I claim that said Pinky Pal will help to promote proper right hand position and technique for trumpet players who use the Pinky Pal.

12. The Pinky Pal recited in claim 11 wherein will help to promote proper right hand position and technique for trumpet players who use the Pinky Pal will honor any movements of the user's right hand pinky without undermining the integrity of said Pinky Pals promotion of proper right hand posture and technique.

13. I claim that the Pinky Pal body is fabricated using ethylene vinyl acetate or foam rubber composite material.
